(19) United States
(12) Patent Application Publication
(10) Pub. No.: US 2010/0160518 A1
(43) Pub. Date: Jun. 24, 2010

(54) Controlled Nucleated Polymer Composition

(75) Inventors: Joseph P. Congdon, Sandy, UT (US); Jean-Francois Croteau, Wilmington, DE (US)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Basell Poliolefine Italia s.r.l., Milan (IT)

(21) Appl. No.: 12/225,360

(22) PCT Filed: Mar. 20, 2007
(86) PCT No.: PCT/EP2007/052665

§ 371 Date: Sep. 19, 2008

Related U.S. Application Data
(60) Provisional application No. 60/784,207, filed on Mar. 21, 2006.

(51) Int. Cl. C08K 5/098; B29C 45/00; C08L 23/16

(52) U.S. Cl. 524/396; 264/328.1; 524/400

(57) ABSTRACT

The present subject matter relates generally to a controlled nucleated polymer composition comprising: (1) a polyolefin resin; (II) a nucleator; and (III) a nucleation regulator.

The present inventive subject matter relates generally to novel polymer compositions, and processes for preparing and using the novel polymer compositions. In a particular aspect, the novel polymer compositions provide better processing properties when used in processing products.

Mechanical properties of polymers are greatly influenced by the crystallinity of the polymers, which in turn affects the range of applications for which the polymers can be used. In many applications, a polymer with a certain degree of crystallinity is required to ensure the polymer performs satisfactorily for the desired application. Accordingly, nucleating agents have been developed and widely used in the polymer field to increase, or at the very least, maintain the crystallinity of polymers.

Nucleating agents directly affect the mechanical properties of polymers by regulating the crystallinity, including the crystallization temperature, the crystallization rate, and the overall percent of crystallinity in a variety of polymers. In particular, nucleating agents generally increase the crystallinity and crystallization temperature, increase the crystallization rate, and increase the overall percent of crystallinity in polymers. By increasing the crystallinity, and thus the overall percent crystallinity of a polymer, the stiffness and heat deflection temperature exhibited by the polymer are improved. As such, a product produced with a polymer having a higher overall percent crystallinity translates into a product exhibiting improved mechanical properties, such as improved stiffness and heat deflection.

For example, U.S. Pat. No. 4,338,228 to Inoue, et al. discusses the use of a combination of nucleating agents along with heat deterioration inhibitors to prevent the reduction of mechanical strength properties of a molded polyolefin product having a large wall thickness obtained by slow cooling.

Additionally, decreasing the time it takes for a polymer to crystallize, i.e., increasing the crystallization rate, is also important in processing polymers to form products. In polymer processing, a faster crystallization rate usually allows for higher productivity in molding and extrusion processes. The higher productivity in molding and extrusion processes is due to the increased rate at which the polymer solidifies. Accordingly, this increased solidification rate translates into a faster processing time. Since a molded or extruded product cannot be passed down a processing line until the product formed from the polymer retains its structural form, a polymer with an increased crystallization rate will ideally produce a molded or extruded product which will retain its structural form in less time than a product produced from a polymer with a lower crystallization rate. Moreover, a polymer with a reasonably high crystallinity and a reasonably high overall percent crystallinity along with a reasonably high crystallization rate can ideally produce a product with reasonable stiffness in a lower amount of time. Thus, more molded or extruded products can be produced in a set period of time.

Nucleating agents are generally known as heterogeneous nucleators, in that they present a heterogeneous surface on polymer melts during cooling, which in turn promotes polymer crystallization through different mechanisms, including epitaxial effects. During the cooling phase of polymer processing, a well-dispersed nucleating agent within the molten polymer will cause the formation of many more polymer crystals at a higher temperature through epitaxial or template-like effects, as compared to the same resin without a nucleating agent. Accordingly, methods have been established, such as the method discussed in U.S. Pat. No. 4,184,026, to Carrock, et al. in an attempt to uniformly disperse nucleating agents within polymers.

In addition to promoting polymer crystallization, nucleating agents increase the temperature at which polymers begin to crystallize (i.e., the crystallization temperature). The crystallization temperature of a polymer, which is denoted as polymer Tc, can be measured by a variety of techniques, including differential scanning calorimetry (DSC). Generally, nucleating agents increase the Tc of polymers. Accordingly, nucleating agents give polymers a higher Tc value, which in turn results in the polymers having a decreased cooling time required for solidification. In production terms, a polymer with a higher Tc value can be used to produce products with a decreased cooling time. A polymer having a decreased cooling time generally results in an improved overall cycle time for processing the polymers into products by, for example, molding or extrusion processes. An improved cycle time, in turn, usually results in an increase in overall productivity.

However, previously discussed U.S. Pat. No. 4,338,228 to Inoue, et al. does not solve the problem of nucleation regulators adversely affecting the mechanical and processing properties bestowed by nucleating agents to polymers, which is discussed in greater detail below.

In addition to nucleating agents, nucleation regulators also affect the mechanical properties of polymers. Nucleation regulators can be used for a wide variety of purposes including, for example, neutralizing acid residues in polymers, increasing the release properties of polymers, and regulating the color and transparency of polymers.

When processing polymers, it is important to neutralize any acid residues within the polymers. Accordingly, if the acid residues within polymers are not sufficiently neutralized, the residues can corrode the processing machinery, which can be very costly to fix or replace. This, of course, also affects productivity since any down time required to fix or replace machinery parts decreases the amount of time available to produce products.

In addition to neutralizing acid residues, nucleation regulators increase the lubricity and release properties of polymers. By increasing the lubricity and release properties of polymers, nucleation regulators can create a small amount of mold release or slip properties, which in turn reduces the probability of the polymers becoming attached or gummed to the processing machinery during run times.

However, nucleation regulators generally, at the very least, function as antagonists to nucleating agents, thus reducing or decreasing the effectiveness of nucleating agents. In particular, one would normally expect nucleation regulators to decrease the crystallinity within a polymer, and reduce the crystallization temperature of a polymer. Accordingly, nucleation regulators can adversely affect the cooling time of polymers by increasing the time required for the polymers, and products produced from the polymers, to become stiff enough to be removed from a processing station. This increase in cooling time increases the overall cycle time of the process, which in turn decreases the overall productivity.

By decreasing or reducing the effectiveness of nucleating agents, nucleation regulators have to be carefully added to polymers. The process of adding nucleation regulators to a polymer containing nucleating agents has to be carefully calculated and monitored to ensure the effectiveness of the nucleating agent is not too adversely affected. If too much nucleation regulator is added, then the affects of the nucleating agent can be completely negated. However, if not enough nucleation regulator is added, then an increased amount of acid residues within the polymer can corrode the processing machinery.

At the very least, even with proper calculation and monitoring, the addition of nucleation regulators to polymers is an extremely inexact science at best. Accordingly, test runs on sample batches need to be performed to ensure the proper proportions of nucleating agents and nucleation regulators have been added to a polymer. These additional test runs and sample batches not only take up time, but also resources.

For these reasons, there remains a need in the art for nucleation regulators that do not reduce or decrease the effectiveness of nucleating agents within polymer compositions. Additionally, there remains a need in the art for polymer compositions that provide better processing properties comprising a nucleating agent and a nucleation regulator. The present subject matter addresses these needs.

In light of the above, it has been unexpectedly found that certain nucleation regulators not only do not decrease or reduce the effectiveness of nucleating agents, but actually increase and enhance the effectiveness of nucleating agents within polymer compositions.

The present subject matter relates generally to polymer compositions comprising a nucleating agent and a nucleation regulator, and more particularly to polymer compositions with improved processing properties comprising a nucleating agent and a nucleation regulator.

In this regard, a preferred aspect of the present subject matter relates to a controlled nucleated polymer composition comprising:

(I) a polyolefin resin;

(II) a nucleator; and

(III) a nucleation regulator. Additionally, another preferred aspect of the present subject matter relates to a controlled nucleated polymer composition comprising:

(I) a polyolefin resin comprising:
(i) from about 65% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 5% to about 35% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene;

(II) sodium benzoate; and

(III) an ionic stearate salt.

Moreover, another preferred aspect of the present subject matter relates to a controlled nucleated polymer composition consisting essentially of:

(I) a polyolefin resin comprising:
(i) from about 65% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 5% to about 35% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene;

(II) about 800 ppm of sodium benzoate; and

(III) about 2000 ppm of calcium stearate.

Yet another preferred aspect of the present subject matter relates to an injection molded part comprising a controlled nucleated polymer composition comprising:

(I) a polyolefin resin;

(II) a nucleator; and

(III) a nucleation regulator.

### Definitions

As used herein, the terms “administering”, “administration”, and like terms refer to any method and/or process which delivers a nucleation regulator to a polyolefin resin comprising a nucleator in such a manner as to provide an increase in the crystallinity, increase in the crystallization temperature, increase in crystallization rate, increase in the overall crystallinity and/or increase in crystal growth of the polyolefin resin comprising the nucleator. The nucleation regulators are preferably administered such that they are randomly dispersed throughout the polyolefin resin.

The phrase “effective amount” refers to an amount of at least one nucleation regulator of the present subject matter contained within the controlled nucleated polymer compositions of the present subject matter to sufficiently regulate the nucleation properties of the nucleators of the present subject matter. Regulation of nucleation properties of the nucleators generally refers to not decreasing the crystallinity, crystallization temperature, crystallization rate, the overall crystallinity and/or decrease crystal growth of a polyolefin resin comprising a nucleator. Effective amounts of the nucleation regulator will vary depending upon the type of polyolefin resin being used, the type of nucleator being used in the polyolefin resin, the amount of nucleator being used in the polyolefin resin, and like factors.

The phrase “reduced cycle time” refers to the amount of time required to process a product comprising a controlled nucleated polymer composition of the present subject matter, which is generally less than the amount of time required to process a product comprising a relatively similar polymer composition not containing a combination of a nucleator and nucleator regulator of the present subject matter. Additionally, the amount of time required to process a product, as used above, is limited to the amount of time required to actually produce a product via a molding or extrusion process, and does not refer to any front end or back end processing, such as preparing the controlled nucleated polymer composition, cleaning the formed product, and similar processes.

The phrase “thin-walled article” refers to an article having at least one wall having a thickness of about 0.2 mm to about 0.8 mm or a flow length to wall thickness ratio (L/T)>200.

All polymer weight percentages and ppm amounts within this disclosure are based on the percent by weight of the final controlled nucleated polymer composition unless otherwise specified, and all totals equal 100% by weight.

### Controlled Nucleated Polymer Compositions

The present subject matter relates to controlled nucleated polymer compositions comprising a polyolefin resin, a nucleator, and a nucleation regulator. It has been unexpectedly found that a combination of the nucleators and nucleation regulators of the present subject matter demonstrate marked improvements in the processing properties of the polyolefin resins of the present subject matter. In particular, a combination of the nucleators and nucleation regulators of the present subject matter can improve the processing properties, for example the flatness and cycle time, of the polyolefin resins of the present subject matter.

In a particularly preferred aspect of the present subject matter, the controlled nucleated polymer compositions comprise in combination at least one nucleator and nucleation regulator of the present subject matter in a ratio ranging from about 5:1 to about 1:5, respectively. In another particularly preferred aspect of the present subject matter, the controlled nucleated polymer compositions comprise in combination at least one nucleator and nucleation regulator of the present subject matter in a ratio ranging from about 3.5:1 to about 1:3.5, respectively. In yet another particularly preferred aspect of the present subject matter, the controlled nucleated polymer compositions comprise in combination at least one nucleator and nucleation regulator of the present subject matter in a ratio of about 1:2.5.

Additionally, the present subject matter relates to products produced from controlled nucleated polymer compositions comprising a polyolefin resin, a nucleator, and a nucleation regulator.

### Polyolefin Resins

The controlled nucleated polymer compositions of the present subject mater can comprise a polyolefin resin comprising a homopolymer or copolymer, wherein the homopolymer or copolymer polyolefin resin comprises monomers having formula (I):

CH₂═CHR¹ (I)

wherein R¹ is hydrogen, a C₁-C₁₀ hydrocarbon, and combinations thereof.

The polyolefin resins of the present subject matter can be produced by conventional processes known in the art, including single and multi-stage reactions, wherein the reactions can be carried out in a gas-phase, liquid phase, or combinations thereof.

In a preferred aspect of the present subject matter, the controlled nucleated polymer compositions of the present subject matter can comprise a polyolefin resin comprising: (i) from about 65% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 5% to about 35% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene.

In another preferred aspect, the controlled nucleated polymer compositions of the present subject matter can comprise a polyolefin resin comprising: (i) from about 75% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 5% to about 25% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene.

In yet another preferred aspect, the controlled nucleated polymer compositions of the present subject matter can comprise a polyolefin resin comprising: (i) from about 85% to about 90% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 10% to about 15% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene.

Additionally, in another preferred aspect, the polyolefin resin can comprise at least one olefin selected from ethylene, propylene, butene, pentene, hexane, heptene, octene, and mixtures thereof. In a particularly preferred aspect of the present subject matter, the polyolefin resin comprises at least one olefin selected from ethylene, propylene, butene, and mixtures thereof. In another preferred aspect of the present subject matter, the polyolefin can be heterophasic in part or whole

Even more so, in a preferred aspect of the present subject matter, the elastomeric copolymer of the controlled nucleated polymer compositions can comprise an intrinsic viscosity from about 1.6 dl/g to about 3.6 dl/g. In yet another preferred aspect of the present subject matter, the elastomeric copolymer of the controlled nucleated polymer compositions can comprise an intrinsic viscosity of about 2.0 dl/g to about 3.4 dl/g.

The controlled nucleated polymer compositions of the present subject matter can preferably comprise a melt flow rate of about 0.1 to about 300 g/10 min. at 230° C. In a particularly preferred aspect of the present subject matter, the controlled nucleated polymer compositions of the present subject matter can comprise a melt flow rate of about 40 to about 200 g/10 min. at 230° C. In another particularly preferred aspect of the present subject matter, the controlled nucleated polymer compositions of the present subject matter can comprise a melt flow rate of about 80 to about 120 g/10 min. at 230° C. In another particularly preferred aspect of the present subject matter, the controlled nucleated polymer compositions of the present subject matter can comprise a melt flow rate of about 100 to about 110 g/10 min. at 230° C.

### Nucleators

In addition to the polyolefin resin, the controlled nucleated polymer compositions of the present subject matter comprise at least one nucleator. The nucleators of the present subject matter can generally increase the crystallinity, increase the crystallization rate, and increase the overall percent of crystallinity in the controlled nucleated polymer compositions of the present subject matter as compared to similar non-nucleated polymer compositions. Additionally, the nucleators of the present subject matter, in combination with the nucleation regulators of the present subject matter, can give the polyolefin resins of the present subject matter superior processing properties, including for example improved flatness and faster cycle time.

The nucleators of the present subject matter can be selected from talc, silca, sodium benzoate, kaolin, aluminum tert-butylbenzoate, dibenzylidene sorbitol, metyldibenzylidene sorbitol, ethyldibenzylidene sorbitol, dimethyldibenzylidene sorbitol, sodium 2,2′-methylene-bis-(4,6,-di-tert-butylphenyl)phosphate, sodium 2,2′-ethylidene-bis(4,6-di-t-butylphenyl)phosphate, bis(p-methylbenzylidene)sorbitol, bis(3,4-dimethylbenzylidene)sorbitol, bis(p-ethylbenzylidene)sorbitol, aluminum hydroxybis[2,4,8,10-tetrakis(1,1-dimethylethyl)-6-hydroxy-12H-dibenzo[d,g][1,3,2]dioxaphoshocin 6-oxidato], and combinations thereof. In a particularly preferred aspect of the present subject matter, the nucleator is sodium benzoate.

The amount of nucleator, or nucleators, within the controlled nucleated polymer compositions can be dependent on the type of nucleator or nucleators being used, the type of polyolefin resin being used, and/or the type of nucleation regulator or regulators being used. However, in a preferred aspect of the present subject matter, the controlled nucleated polymer compositions can comprise a nucleator in an amount from about 100 ppm to about 2000 ppm. In another preferred aspect of the present subject matter, the controlled nucleated polymer compositions can comprise a nucleator in an amount from about 400 ppm to about 1200 ppm.

In a particularly preferred aspect of the present subject matter, the controlled nucleated polymer compositions comprise about 800 ppm of sodium benzoate.

Alternatively, the nucleators of the present subject matter can be present in the controlled nucleated polymer compositions based on weight percent. In a preferred aspect of the present subject matter, the controlled nucleated polymer compositions can comprise from about 0.01% by weight to about 0.2% by weight of a nucleator. In another preferred aspect of the present subject matter, the controlled nucleated polymer compositions can comprise from about 0.05% by weight to about 0.15% by weight of a nucleator.

In a particularly preferred aspect of the present subject matter, the controlled nucleated polymer compositions comprise about 0.05% by weight to about 0.1% by weight of a nucleator.

### Nucleation Regulators

In addition to comprising a nucleator, the controlled nucleated polymer compositions further comprise at least one nucleation regulator. The nucleation regulators of the present subject matter are generally of formula (II):

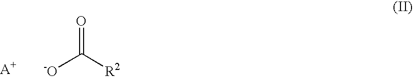

wherein R² can be a C₇-C₂₀ straight or branched alkane, a C₇-C₂₀ straight or branched alkene, a C₇-C₂₀ straight or branched alkyne, a C₇-C₂₀ straight or branched alkanol, a C₇-C₂₀ straight or branched alkenol, a C₇-C₂₀ straight or branched alkynol, a C₇-C₂₀ straight or branched ester, or a C₇-C₂₀ straight or branched ether; and
A⁺ can be an ion selected from calcium, sodium, zinc, aluminum, magnesium, potassium, and lithium.
   Additionally, the nucleation regulators of the present subject matter can have formula (III):

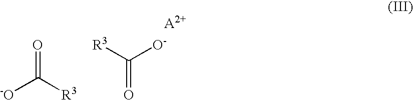

wherein R² can be a C₇-C₂₀ straight or branched alkane, a C₇-C₂₀ straight or branched alkene, a C₇-C₂₀ straight or branched alkyne, a C₇-C₂₀ straight or branched alkanol, a C₇-C₂₀ straight or branched alkenol, a C₇-C₂₀ straight or branched alkynol, a C₇-C₂₀ straight or branched ester, or C₇-C₂₀ straight or branched ether, and combinations thereof; and
A²⁺ can be an ion selected from calcium, sodium, zinc, aluminum, magnesium, potassium, and lithium.

In a preferred aspect of the present subject matter, the nucleation regulator is an ionic stearate salt. In a particularly preferred aspect of the present subject matter, the nucleation regulator is selected from calcium stearate, sodium stearate, zinc stearate, aluminum stearate, magnesium stearate, potassium stearate, lithium stearate, and combinations thereof.

In another particularly preferred aspect of the present subject matter, the nucleation regulator is calcium stearate.

The amount of nucleation regulator, or regulators, within the controlled nucleated polymer composition can be dependent on the type of nucleation regulator or regulators being used, the type of polyolefin resin being used, and/or the type of nucleator or nucleators being used. In a preferred aspect of the present subject matter, the controlled nucleated polymer compositions can comprise from about 100 ppm to about 10,000 ppm of a nucleation regulator. In another preferred aspect of the present subject matter, the controlled nucleated polymer compositions can comprise from about 500 ppm to about 4,000 ppm of a nucleation regulator.

In a particularly preferred aspect of the present subject matter, the controlled nucleated polymer compositions comprise about 2000 ppm of a nucleation regulator.

Alternatively, the nucleation regulators of the present subject matter can be present in the controlled nucleated polymer compositions based on weight percent. In a preferred aspect of the present subject matter, the controlled nucleated polymer compositions can comprise from about 0.01% by weight to about 10% by weight of a nucleation regulator. In another preferred aspect of the present subject matter, the controlled nucleated polymer compositions can comprise from about 0.05% by weight to about 4% by weight of a nucleation regulator.

In a particularly preferred aspect of the present subject matter, the controlled nucleated polymer compositions comprise about 0.2% by weight to about 2% by weight of a nucleation regulator.

The amount of a nucleation regulator, or combination of nucleation regulators of the present subject matter, can be administered to a polyolefin resin comprising at least one nucleator in an effective amount to regulate the nucleation properties of the nucleator, or combination of nucleators.

The administration of an effective amount of a nucleation regulator, or combination of nucleation regulators, to a polyolefin resin can be carried out in various ways. Non-limiting examples of administration techniques which can be used to administer an effective amount of a nucleation regulator, or combination of nucleation regulators of the present subject matter, to a polyolefin resin comprising a nucleator include, dry mixing and melt mixing. Additionally, an effective amount of a nucleation regulator, or combination of nucleation regulators, can be administered to a polyolefm resin of the present subject matter by pre-mixing an additive polyolefin mixture and adding the additive polyolefin mixture to the polyolefin resin, wherein the additive polyolefin mixture comprises a polyolefin and a nucleation regulator, or combination of nucleation regulators, of the present subject matter.

### Additives

The controlled nucleated polymer compositions of the present subject matter can also generally contain additives well known in the art. In particular, the controlled nucleated polymer compositions of the present subject matter can comprise, in addition to at least one nucleator and at least one nucleation regulator, at least one slip additive, antistatic addititve, antioxidant, stabilizer, lubricant, mold release agent, plasticizer, dye, pigment, anti-fungal, anti-microbial, film cavitating agent, flame retardant, filler, and combinations thereof.

Non-limiting examples of possible additives include eurucamide, sterically hindered phenols, sterically hindered amines, UV stabilizers, processing stabilizers such as phosphites or phosphonites, acid scavengers such as dihydrotalcite, as well as calcium, zinc and sodium caprylate salts, fatty acids, calcium, sodium or zinc salts of fatty acids, fatty acid amides or low molecular weight polyolefm waxes, calcium carbonate, chalk or glass fibers, and combinations thereof.

In particular, the controlled nucleated polymer compositions of the present subject matter can comprise up to about 10% by weight of at least one additive. In general, any additive added to the nucleated polymer compositions can be incorporated during granulation of the polyolefin resin.

### Preparation of Molded Parts

In a preferred aspect of the present subject matter, the controlled nucleated polymer compositions can be used to produce molded parts. As previously discussed, the controlled nucleated polymer compositions of the present subject matter demonstrate marked improvements in processing properties, which in turn allows the controlled nucleated polymer compositions to be used more effectively and/or efficiently than previously known polyolefin resins to produce molded parts. In particular, the controlled nucleated polymer compositions can be used to produce thin walled articles having an exceptional balance of properties, such as for example, exceptional flatness.

The controlled nucleated polymer compositions of the present subject matter can be used to produce thin walled articles having an exceptional balance of properties, including for example flatness, due to a combination of the nucleators and the nucleation regulators of the present subject matter unexpectedly decreasing the crystallization temperature while maintaining the crystallization rate of the polyolefin resins of the present subject matter in a better combination than that of any previously known polyolefin resin containing either a nucleator, a nucleation regulator, or neither.

In addition to providing a better balance of properties (e.g., increasing the flatness) of molded parts comprising the controlled nucleated polymer compositions of the present subject matter, the molded parts can be produced at a lower cycle time than molded parts comprising previously known polyolefin resins containing either a nucleator, a nucleation regulator, or neither. The processing cycle time needed to produce the molded parts can be decreased due to the controlled nucleated polymer compositions comprising a combination of a nucleator and nucleation regulator exhibiting an unexpected decrease in the crystallization temperature while maintaining the crystallization rate compared to previously known polyolefin resins containing either a nucleator, a nucleation regulator, or neither.

The molded parts of the present subject matter can be produced by conventional processes well known in the art. In particular, thin-walled articles having an exceptional balance of properties, including for example flatness, can be produced by known injection molding apparatuses at a reduced cycle time.

### Test Methods

Melt flow rate as used throughout this disclosure is determined at 230° C. and a load of 2.16 kg/L pursuant to ASTM D1238.

Intrinsic viscosity as used throughout this disclosure is determined pursuant to ASTM D1601-99.

Differential Scanning Calorimetry (DSC) as used throughout this disclosure was determined pursuant to ASTM E793-01

### EXAMPLES

The following examples are illustrative of preferred controlled nucleated polymer compositions and products produced there from, and are not intended to be limitations thereon. All polymer weights are mean average weights. All percentages are based on the percent by weight of the final polymer composition prepared unless otherwise indicated, and all totals equal 100% by weight.

### Example 1

The following example illustrates a preferred controlled nucleated polymer composition:

| | % W/W |
|---|---|
| SC970S¹ | 99.25% |
| Irganox 1010² | 0.06% |
| Irgafos 168³ | 0.06% |
| GMS-90⁴ | 0.35% |
| Sodium Benzoate | 0.08% |
| Calcium Stearate | 0.2% |
| | 100.0% |

¹A commercially available polyolefin resin comprising a heterophasic copolymer available from Basell
²Commercially available from Ciba Specialty Chemcials
³Commercially available from Ciba Specialty Chemcials
⁴Pationic 901 available from American Ingredients Company

### Example 2

The following example illustrates another preparation of a preferred controlled nucleated polymer composition:

| | % W/W |
|---|---|
| SC973⁵ | 99.8% |
| Calcium Stearate | 0.2% |
| | 100.0% |

⁵Pro-fax ™ Ultra SC973; a commercially available polyolefin resin comprising a nucleated heterophasic copolymer available from Basell

### Preparation of Example 1

1. SC970S is mixed with Irganox 1010, Irgafos 168, GMS-90, sodium benzoate, and calcium stearate in a mixer manufactured by Mixaco Maschinenbau for about 4 minutes in a 200 lb batch to form a heterogeneous SC970S mixture.

2. The heterogeneous SC970S mixture is then fed into a 3½-inch single screw extruder manufactured by Sterling Extruder Corp. equipped with a 60/100/60 mesh screen pack and a 30-hole die at 425° F. All barrel temperature zones are set to 425° F., and the screw speed is set at 144 rpm. The heterogeneous SC970S mixture is melted into a molten controlled nucleated polymer composition in the extruder.

3. The molten controlled nucleated polymer composition is then extruded from the extruder through a die as strands, which are subsequently cooled in a water bath to form reasonably solidified strands.

4. The reasonably solidified strands are then cut into pellets.

### Preparation of Example 2

1. SC973 is mixed with calcium stearate in a mixer manufactured by Mixaco Maschinenbau for about 4 minutes in a 200 lb batch to form a heterogeneous SC973 mixture.

2. The heterogeneous SC973 mixture is then fed into a 3½-inch single screw extruder manufactured by Sterling Extruder Corp. equipped with a 60/100/60 mesh screen pack and a 30-hole die at 425° F. All barrel temperature zones are set to 425° F., and the screw speed is set at 144 rpm. The heterogeneous SC973 mixture is melted into a molten controlled nucleated polymer composition in the extruder.

3. The molten controlled nucleated polymer composition is then extruded from the extruder through a die as strands, which are subsequently cooled in a water bath to form reasonably solidified strands.

4. The reasonably solidified strands are then cut into pellets.

### Example 3

Preparation of a molded article comprising a controlled nucleated polymer composition:

1. An amount of a controlled nucleated polymer composition is supplied to an injection molding apparatus.

2. The controlled nucleated polymer composition is melted into a molten form and then injected into a mold having a pre-determined size and shape to produce a semi-solid molded article.

3. The semi-solid molded article is allowed to cool to produce a molded article which reasonably retains its size, shape, and structural integrity when removed from the mold at a reduced cycle time.

### Example 4

Administration of a nucleation regulator to a polyolefin resin:

1. An amount of 0.4 lbs of calcium stearate is added to 200 lbs of a polyolefin resin comprising about 0.08% by weight of sodium benzoate.

2. The calcium stearate is then dry mixed with the polyolefin resin comprising about 0.2% by weight of sodium benzoate to produce a heterogeneous mixture.

3. The heterogeneous mixture is then melted to form a molten polyolefin resin comprising sodium benzoate and calcium stearate.

TABLE 1
In addition to the examples listed above, the below table lists several
controlled nucleated polymer compositions of the present subject matter,
and properties which contribute to their better processing properties.

| Formulation | A | B | C | D | E | F (Control) |
|---|---|---|---|---|---|---|
| SC970S | 100 | 100 | 100 | 100 | 100 | 100 |
| AO B-225 | 0.14 | 0.14 | 0.14 | 0.14 | 0.14 | 0.14 |
| Calcium Stearate | 0 | 0.05 | 0.1 | 0.15 | 0.2 | 0.05 |
| Sodium Benzoate | 0.08 | 0.08 | 0.08 | 0.08 | 0.08 | 0 |

| | Sample | | | | | |
|---|---|---|---|---|---|---|
| Parameter | A | B | C | D | E | F |
| T_{C} Φ = 10° C./min. | 127.56 | 119.32 | 118.29 | 118.18 | 117.2 | 118.64 |
| C₀ | 10.581 | 50.185 | 41.630 | 61.412 | 77.900 | 45.167 |
| C₁ | 5.179 | 8.207 | 7.062 | 8.223 | 8.333 | 6.932 |
| n | 1.933 | 2.880 | 2.756 | 3.016 | 3.178 | 2.810 |
| k | 2.764 | 5.674 | 3.893 | 5.452 | 5.350 | 3.608 |
| t_{1/2} (min) | 0.489 | 6.482 | 0.535 | 0.505 | 0.526 | 0.556 |
| τ (min⁻¹) | 2.045 | 2.075 | 1.870 | 1.982 | 1.902 | 1.799 |
| CaSt (pph) | 0 | 0.05 | 0.1 | 0.15 | 0.2 | 0.05 |
| ΔE (kJ mol⁻¹) | −334.2 | −382.4 | −280.7 | −332.7 | −335.1 | −292.1 |

DSC was performed on samples A through F, and the following equations were used for calculating the above data. Avrami n is related to crystallization geometry, k is a rate constant, malkin C₀ is proportional to the ratio of crystal growth to primary crystallization processes, and Malkin C₁ is a rate constant.

$$\begin{matrix}Crystallization Fraction as Function of Temperature & \\ X ( T ) = \frac{{\int }_{{T}_{0}}^{T} ( \frac{d {H}_{C}}{d T} ) d T}{Δ {H}_{C}} & Equation 1\end{matrix}$$

where:
X(T) is weight fraction crystallized at temperature T;
ΔH_{C}=Overall heat of crystallization—area under the crystallization curve of the DSC experiment;
dH_{C}=enthalpy of crystallization released during infinitesimal temperature range dT;
T₀=defined as the temperature at crystallization onset taken from the DSC curve;
T=temperatures during crystallization process.

$$\begin{matrix}Conversion to Time Domain & \\ t = \frac{{T}_{0} - T}{φ} & Equation 2\end{matrix}$$

where:
t=time in minutes or seconds
T₀=temperature at crystallization onset—extrapolated tangent line from cooling curve determined by DSC instrument;
T=Temperature during crystallization;
φ=cooling rate (° C./min).

### Equation 3—Avrami Equation

X(t)=1−exp(−kₐtⁿ^{ₐ})

### Equation 4—Linearized Avrami Equation

log(−ln(1−X(t))=log kₐ+nₐ log t

$$\begin{matrix}Calculation of Half \text{-} Times & \\ {t}_{1 / 2} = {( \frac{ln 2}{k} )}^{1 / n} & Equation 5 \\ Calculation of Conversion & \\ τ = \frac{1}{{t}_{1 / 2}} & Equation 6\end{matrix}$$

### Equation 7—Activation Energy Based on Kinetics Data

k^{1/n}=k₀ exp(−ΔE/RT_{X})

$$\begin{matrix}Activation Energy based on Isoconversional Method & \\ \frac{d X ( t )}{d t} = {A}_{0} exp ( - Δ E / {RT}_{X} ) & Equation 8 \\ Malkin Equation and Relation to Avrami Parameters & \\ X ( t ) = 1 - \frac{{C}_{0} + 1}{{C}_{0} + exp ( {C}_{0} t )} \\ where \\ {C}_{0} = 4 n - 4 \\ {C}_{1} = ln ( 4 n - 2 ) {( \frac{k}{ln ( 2 )} )}^{1 / n} & Equation 9\end{matrix}$$

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1-85. (canceled)

86. A controlled nucleated polymer composition comprising:
(I) a polyolefin resin;
(II) a nucleator; and
(III) a nucleation regulator.

87. The controlled nucleated polymer composition of claim 86, wherein said polyolefin resin comprises: (i) from about 65% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85,% by weight; and (ii) from about 5% to about 35% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene.

88. The controlled nucleated polymer of claim 87, wherein said elastomeric copolymer is heterophasic and comprises ethylene and propylene.

89. The controlled nucleated polymer composition of claim 87, wherein said elastomeric copolymer comprises an intrinsic viscosity from about 1.6 dl/g to about 3.6 dl/g

90. The controlled nucleated polymer composition of claim 86, wherein said controlled nucleated polymer composition comprises a melt flow rate of about 0.1 to about 300 g/10 min. at 230° C.

91. The controlled nucleated polymer composition of claim 86, wherein said controlled nucleated polymer composition comprises a melt flow rate of about 40 to about 200 g/10 min. at 230° C.

92. The controlled nucleated polymer composition of claim 86, wherein said controlled nucleated polymer composition comprises a melt flow rate of about 80 to about 120 g/10 min. at 230° C.

93. The controlled nucleated polymer composition of claim 86, wherein said nucleator is selected from talc, silca, sodium benzoate, kaolin, aluminum tert-butylbenzoate, dibenzylidene sorbitol, metyldibenzylidene sorbitol, ethyldibenzylidene sorbitol, dimethyldibenzylidene sorbitol, sodium 2,2′-methylene-bis-(4,6,-di-tert-butylphenyl)phosphate, sodium 2,2′-ethylidene-bis(4,6-di-t-butylphenyl)phosphate, bis (p-methylbenzylidene)sorbitol, bis(3,4-dimethylbenzylidene)sorbitol, bis(p-ethylbenzylidene)sorbitol, aluminum hydroxybis[2,4,8,10-tetrakis(1,1-dimethylethyl)-6-hydroxy-12H-dibenzo[d,g][1,3,2]dioxaphoshocin 6-oxidato], and mixtures thereof.

94. The controlled nucleated polymer composition of claim 86, wherein said nucleator is sodium benzoate.

95. The controlled nucleated polymer composition of claim 86, wherein said controlled nucleated polymer composition comprises from about 100 ppm to about 2000 ppm of said nucleator.

96. The controlled nucleated polymer composition of claim 86, wherein said controlled nucleated polymer composition comprises from about 400 ppm too 1200 ppm of said nucleator.

97. The controlled nucleated polymer composition of claim 86, wherein said controlled nucleated polymer composition comprises about 800 ppm of said nucleator.

98. The controlled nucleated polymer composition of claim 86, wherein said nucleation regulator has formula (II): 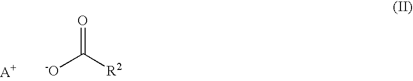
wherein
R² can be a C₇-C₂₀ straight or branched alkane, a C₇-C₂₀ straight or branched alkene, a C₇-C₂₀ straight or branched alkyne, a C₇-C₂₀ straight or branched alkanol, a C₇-C₂₀ straight or branched alkenol, a C₇-C₂₀ straight or branched alkynol, a C₇-C₂₀ straight or branched ester, or a C₇-C₂₀ straight or branched ether; and
A⁺ can be an ion selected from calcium, sodium, zinc, aluminum, magnesium, potassium, and lithium.

99. The controlled nucleated polymer composition of claim 86, wherein said nucleation regulator has formula (III): 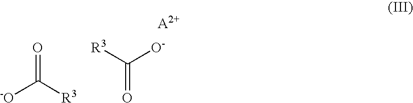
wherein
R³ can be a C₇-C₂₀ straight or branched alkane, a C₇-C₂₀ straight or branched alkene, a C₇-C₂₀ straight or branched alkyne, a C₇-C₂₀ straight or branched alkanol, a C₇-C₂₀ straight or branched alkenol, a C₇-C₂₀ straight or branched alkynol, a C₇-C₂₀ straight or branched ester, a C₇-C₂₀ straight or branched ether, and combinations thereof; and
A²⁺ can be an ion selected from calcium, sodium, zinc, aluminum, magnesium, potassium, and lithium.

100. The controlled nucleated polymer composition of claim 86, wherein said nucleation regulator is an ionic stearate salt.

101. The controlled nucleated polymer composition of claim 86, wherein said nucleation regulator is selected from calcium stearate, sodium stearate, zinc stearate, aluminum stearate, magnesium stearate, potassium stearate, and lithium stearate.

102. The controlled nucleated polymer composition of claim 86, wherein said controlled nucleated polymer composition comprises from about 100 ppm to about 10,000 ppm of said nucleation regulator.

103. The controlled nucleated polymer composition of claim 86, wherein said controlled nucleated polymer composition comprises from about 500 ppm to about 4,000 ppm of said nucleation regulator.

104. A controlled nucleated polymer comprising:
(I) a polyolefin resin comprising:
(i) from about 65% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 5% to about 35% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene;
(II) sodium benzoate; and
(III) an ionic stearate salt.

105. The controlled nucleated polymer composition of claim 104, wherein said elastomeric copolymer comprising an intrinsic viscosity from about 1.6 dl/g to about 3.6 dl/g.

106. The controlled nucleated polymer composition of claim 104, wherein said elastomeric copolymer comprises an intrinsic viscosity from about 2.0 dl/g to about 3.4 dl/g.

107. The controlled nucleated polymer composition of claim 104, wherein said ionic stearate salt is selected from calcium stearate, sodium stearate, zinc stearate, aluminum stearate, magnesium stearate, potassium stearate, and lithium stearate.

108. The controlled nucleated polymer composition of claim 104, wherein said ionic stearate salt is calcium stearate.

109. The controlled nucleated polymer composition of claim 104, wherein said controlled nucleated polymer composition comprises from about 100 ppm to about 10,000 ppm of said ionic stearate salt.

110. The controlled nucleated polymer composition of claim 104, wherein said controlled nucleated polymer composition comprises from about 500 ppm to about 4,000 ppm of said ionic stearate salt.

111. The controlled nucleated polymer composition of claim 104, wherein said controlled nucleated polymer composition comprises about 2,000 ppm of said ionic stearate salt.

112. A controlled nucleated polymer composition consisting essentially of:
(I) a polyolefin resin comprising:
(i) from about 65% to about 95% by weight of a propylene homopolymer, or a copolymer selected from the group consisting of (a) propylene and ethylene, (b) propylene, ethylene and a C₄-C₈ α-olefin, and (c) propylene and a C₄-C₈ α-olefin, the copolymer having a propylene content of more than 85% by weight; and (ii) from about 5% to about 35% by weight of an elastomeric copolymer selected from the group consisting of (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene;
(II) about 800 ppm of sodium benzoate; and
(III) about 2000 ppm of calcium stearate.

113. An injection molded part comprising a controlled nucleated polymer composition comprising:
(I) a polyolefin resin;
(II) a nucleator; and
(III) a nucleation regulator.

114. A process for producing an injection molded part comprising molding a controlled nucleated polymer composition comprising:
(I) a polyolefin resin;
(II) a nucleator; and
(III) a nucleation regulator,
wherein said process comprises a reduced cycle time.

115. The process of claim 114, wherein said injection molded part is a thin walled article.

116. The process of claim 114, wherein said thin walled article has a thickness of about 0.2 mm to about 0.8 mm.

117. The process of claim 114, wherein said thin walled article has a flow length to wall thickness ratio greater than 200.
